(19) United States
(12) Patent Application Publication
(10) Pub. No.: US 2009/0091170 A1
(43) Pub. Date: Apr. 9, 2009

(54) Chair seat having a resilient seatrest/backrest, method of manufacturing same and carbon fibre material used as a spring

(76) Inventors: Norbert Grentzelius, Aby (SE); Ann Sandell, Soderkoping (SE); Lennart Noack, Norrkoping (SE); Stefan Hultgren, Norrkoping (SE)

Correspondence Address: DICKSTEIN SHAPIRO LLP, 1825 EYE STREET NW, Washington, DC, 20006-5403, US

(21) Appl. No.: 11/919,697

(22) PCT Filed: Apr. 24, 2006
(86) PCT No.: PCT/SE2006/000471

§ 371 Date: Feb. 29, 2008

(30) Foreign Application Priority Data
May 4, 2005 (SE) 0501022-8

(51) Int. Cl. A47C 1/024; F16F 1/14

(52) U.S. Cl. 297/301.3; 267/154

(57) ABSTRACT

A chair seat adapted to be mounted on or in a frame, and comprising a seat part (4) and a backrest part (5), which parts are functionally separate units, and which are joined by a spring means which allows the backrest part to move resiliently in relation to the seat part, and in which the spring means comprises one or more thin flexible strips of a spring material, preferably a carbon fibre web material, comprising a flat upper spring part (2a) which is fixed to the backrest part (5) of the chair seat and a flat lower spring part (2b) which is fixed to the seat part (4) of the chair seat, and in which the spring means (2) is formed with a curved spring part (8) between the two flat spring parts (2a, 2b) which is substantially free from the seat and the backrest, and which provides a spring action and a counter spring action of the backrest (5) in relation to the seat part (4).

The present invention relates to a chair seat adapted to be mounted on or in a support frame, and comprising a seat and a backrest, which parts are functionally separate units, and which are joined by means of a spring, which allows the backrest to move resiliently back and forth in relation to the seat, and in which the seat and the backrest, respectively, can move resiliently in relation to each other. The invention also relates to a method for the manufacture of such a chair seat, and to a spring for use in such chair seat, which spring is made of a carbon fibre composite material.

The chair seat according to the invention has, in the first place, been developed as the solution of the problem to provide a flexible and comfortable chair seat for disabled persons, for instance for persons suffering from spasm and other non-controllable body twitching. The chair seat, and the frame, on which the chair seat is mounted, can be of various types, like a conventional chair, a lean chair and other types of ordinary chairs, but it can preferably also be formed as a wheel chair.

Persons having non-controllable twitching and turnings create large forces on the chair, in particular on the backrest, and it has therefore been considered necessary that the seat and the backrest of the chair seat are formed as functionally separate chair units which are joined by some type of spring. The seat and the backrest can be formed as an integral unit, but in such case it ought to exist a web or a weakened part between the chair seat and the backrest so that said parts can move, preferably resiliently, in relation to each other.

Priorly known constructions of chair seats, in which the chair seat and the backrest are formed as an integral unit do not have any apparent resiliency between the seat and the backrest. Certain types of chairs are formed with a frame of spring steel tubes of bars on which the seat and the backrest are mounted. In such cases there is a risk that there appear damages in the frame when subjected to non-controllable turnings of the seated person, or that the metal tubes or bars can be subjected to fatigue and can break.

It is known to join a seat and a backrest by means or coil springs, or preferably gas springs. Such springs generally have been mounted aside of the seat and the backrest. They thereby provide projecting parts which may knock against objects like doors, door frames, furniture and other objects. Such exterior springs provide a complicated and bulky construction, the gas springs may leak gas and oil, and it may be necessary to adjust same for different purposes.

The basis of the present invention has been the solve the problem of forming a chair seat with a flexible and strong spring means between the seat and the backrest, which spring means can preferably be shaped individually formed for any individual person as concerns shape, size and weight, and which spring means in so thin and flexible that it can well be introduced hidden, or inserted against the seat and the backrest of the chair. As a non limiting example can be mentioned that a seat according to the invention, useful for a grown up person, can be formed with two parallel and co-operating springs made of a carbon fibre/epoxy or aramid material having a thickness of the composite carbon fibre material of 5-6 mm and a width of each carbon fibre spring of about 35-40 mm. Such a composite spring can be formed for being able to withstand the stresses that may appear from persons of various weights, even persons providing strong twitching and turnings of the body.

According to the invention the seat and the backrest of the chair are functionally joined by means of one or more springs of a carbon fibre material. Said carbon fibre material can be carbon fibre fabrics which are laid in several layers on top of each other and which are trussed by some suitable plastic material like epoxy, aramid material or any other strong and resistant plastic material. The composite carbon fibre spring material is preferably formed following shape, size and weight of the person for which the chair is intended to be used. It is possible to form an impression, or make a pattern of the back, the seat and thighs of the person in question, and out of said impression or pattern make a mould both of the chair seat and the backrest of the chair, which are interconnected by means of one or more carbon fibre springs.

The manufacture of the chair and according to the invention is made in that
a model is formed of the back, the seat and the thighs of the person for which the chair is intended,
the model is used for casting of seat and backrest in the manufacture of a framework for the seat and the backrest of the chair seat, adapted to the said person as concerns shape and size,
a pattern is made, for instance of wood, having a shape and size corresponding to the model and used for making a thin and flat spring means, e.g. a composite carbon fibre spring,
a spring material, for instance a carbon fibre web material is built up, or is formed on the spring pattern and is interconnected by means of an epoxy resin, an aramid resin or another suitable material,
the composite spring material, for instance the carbon fibre spring material is hardened by means of heat and pressure,
two or more springs, e.g. composite carbon springs, are screwed, riveted, or secured in another way, to the exterior side of the frames of the seat and the backrest of the chair seat,
cushions are applied and fixed to the frames for the seat and the backrest, and
the entire unit comprising seat and backrest are mounted on a frame as known per se thereby providing a chair, a wheel chair of a similar object.

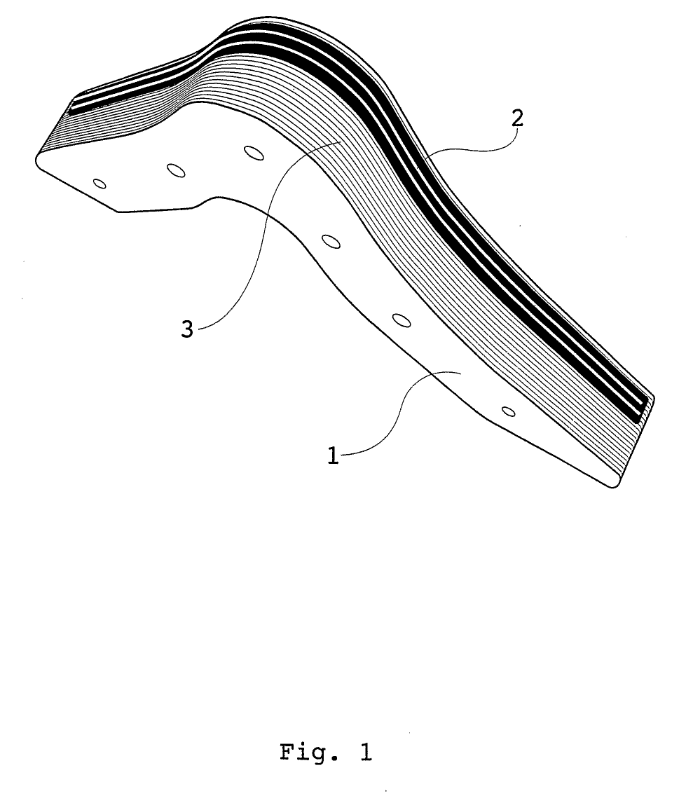

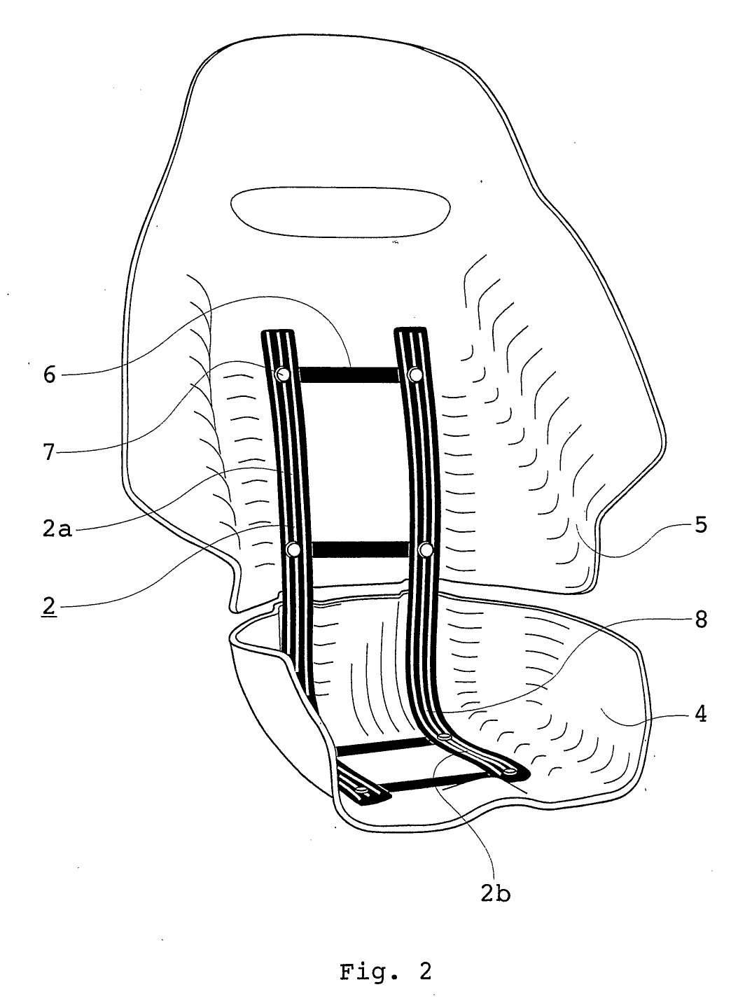

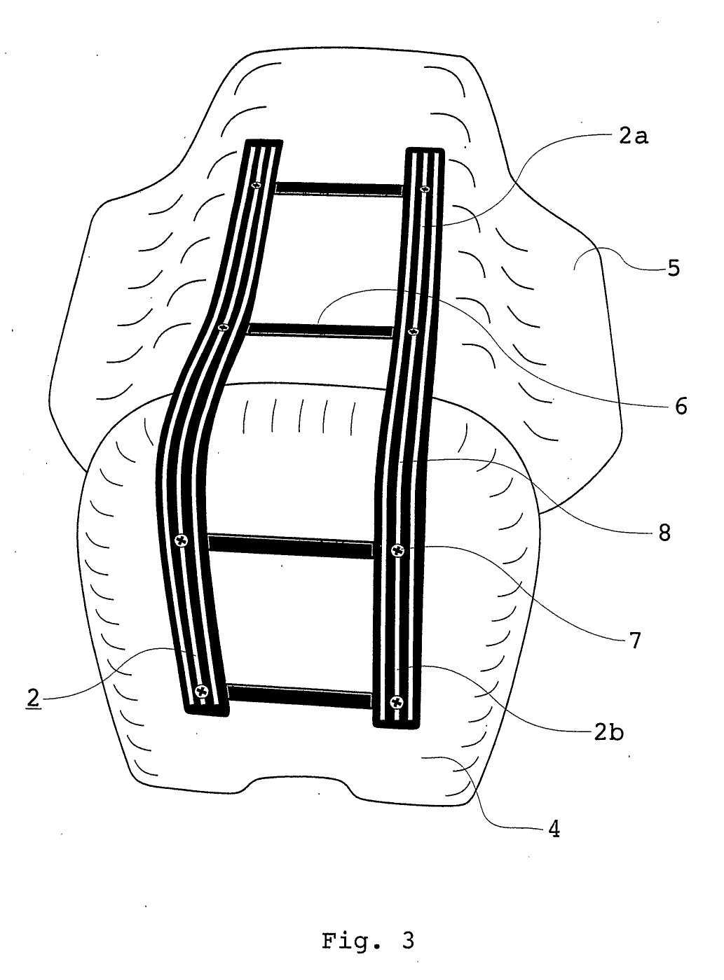

Now the invention is to be shown and described more closely in connection to the accompanying drawings, which diagrammatically illustrate the invention. FIG. 1 shows a perspective view of a pattern on which the composite carbon spring can be formed. FIG. 2 shows, in a front perspective view, a chair seat comprising a seat and a backrest, which parts are joined by means of two interiorly of the chair seat provided parallel composite carbon springs which are preferably interconnected by transversally extending and parallel links, and which springs are fixed to the seat and the backrest frameworks by means of rivets or bolts. FIG. 3 is a chair seat shown in a perspective view from underneath and comprising a seat framework and a backrest framework which are joined by means of two exteriorly provided carbon springs which are interconnected by means of parallel links.

For the manufacture of a chair seat useful for a disabled person, for instance a spastic person, there is thus formed a model corresponding to the back, the backside and the thighs of the actual person. FIG. 1 shows a pattern, corresponding to said model, on which a thin spring can be made. In this case the pattern is a wooden framework 1 onto which material for a spring 2 is applied, which material exactly follows the outer contour 3 of the pattern. It is important that the ready spring provides a straight and flat spring part 2a which can be fixedly connected to the backrest 5 and a corresponding straight and flat spring part 2b, which can be fixedly connected to seat 4. The spring material can be thin spring steel bars, or bars of another spring material, but in a specific embodiment of the invention the spring material is a composite carbon fibre material. It has surprisingly proved that carbon fibre materials are well suited as spring materials, in the first place depending it's the high tensile strength and its low density. Normally the carbon fibre material has a modulus of elasticity of 265-440 GPa, a tensile strength of 2700-6400 MPa, a yield point of 0.7- 2.2% and a density of 1.77-1.93 kg/dm³. The carbon fibre material is supplied as a basic material comprising one or more carbon fibre webs and a basic binder material, generally comprising an epoxy or an aramid resin. After the basic material for the spring 2 has been formed on the pattern 1 it is hardened by means of heat and pressure, whereby it provides a thin composite spring having very good spring properties and return spring properties.

Such a composite carbon fibre spring is so thin that it can very well be placed between the framework of a seat and a backrest of a chair seat, on which framework a cushion can thereafter be applied. As an example can be mentioned that a spring of a composite carbon fibre material can have a thickness of only 5-6 mm and a width of 25-40 mm, which provides a suitable resiliency between the seat and the backrest for a person having a weight of up to about 100 kg. Of course the thickness and the width of the spring 2 can be varied upon need, and it can be made thicker and narrower respective wider. Carbon fibre springs are preferably supplied in various types for use for persons having different weights, for instance as standard springs of type 1, 2, 3, 4 etc.

In FIG. 2 is shown a perspective view of a chair seat, for instance for being mounted on a wheel chair frame, and comprising a seat framework 4 and a backrest framework 5, which are, in the illustrated case, formed as separate parts, which are interconnected by means of two carbon springs 2 which are preferably interconnected by means of two cross bars 6, and which are attached to the seat and the backrest by means of bolts or rivets 7.

As shown in FIG. 3 it is alternatively possible to mount the carbon fibre springs on the exterior side of the chair framework.

It is also possible to mount the carbon fibre springs on a (not illustrated) U-shaped bar, possibly a first section bar for the backrest part and a second section bar for the seat part. This involves the advantage that the free resilient part of the carbon fibre spring providing the curved part 8 between the seat and the backrest can be formed with various lengths: a shorter spring curve 8 provides a stiffer resilience; a longer spring curve 8 provides a softer, more flexible spring.

The cross bars 6 between the two springs 2 which are shown in FIGS. 2 and 3 makes the spring torsion rigid. It is, however, possible to form a spring so that it is possible to rotate the backrest part 5 in relation to the seat part 4, what can be of advantage for making it possible for a person in the chair, for instance the wheel chair, to turn slightly aside. In this case the spring can be formed as one single central spring having a strength and resilience capability corresponding to that of the double spring as shown in FIGS. 2 and 3.

The invention also relates to a spring made of a composite carbon fibre material, for instance a spring which is mounted between a seat part and a backrest part of a chair seat, for instance intended to be used on a wheel chair frame, and which with a curved spring part which is free from the seat and the backrest provides the resilient part of the unit, over which the backrest is elastic and return elastic in relation to the seat part, whereas flat parts of the spring extending from the said curved spring part are fixedly connected in direct contact against the seat part and the backrest part, respectively.

REFERENCE NUMERALS

| | |
|---|---|
| 1 | wooden framework (pattern) |
| 2 | spring |
| 2a | flat spring part |
| 2b | flat spring part |
| 3 | outer contour (of pattern) |
| 4 | seat part |
| 5 | backrest part |
| 6 | cross bar |
| 7 | bolt, rivet |
| 8 | curved spring part |

1. Chair seat adapted to be mounted on or in a frame and comprising a seat part (4) and a backrest part (5), which parts are functionally separate units, and which are joined by a spring means which allows the backrest to move resiliently in relation to the seat, characterized in that the spring means comprises one or more thin flexible strips of a baked and hardened carbon fiber material, and
comprising a flat, upper spring part (2a) which is secured to the backrest part (5) of the chair seat, and a flat, lower spring part (2b) which is secured to the seat part (4) of the chair seat, and in which the spring means is formed with a curved spring part (8) between the two flat spring parts (2a, 2b), which is located free from the seat part (4) and the backrest part (5), and which provides a spring suspension and re-spring suspension of the backrest part (5) in relation to the seat part (4).

2. Chair seat according to claim 1, characterized in that the spring means is formed resilient about the curved, free spring portion (8) but is torsion rigid and comprises two springs (2) arranged aside of each other, which springs are interconnected by means of cross bars (6).

3. Chair seat according to claim 1, characterized in that each spring (2) is secured to the backrest (5) and the seat (4), respectively, of the chair seat with the flat portions (2a, 2b) thereof by means of bolts or rivets.

4. Chair seat according to claim 1, characterized in that the spring or springs (2) are mounted on the interior side or the exterior side of the seat part (4) and the backrest part (5) of the chair seat.

5. Chair seat according to claim 1, characterized in that the spring of carbon fiber material is composed of several layers of a carbon fiber web which are trussed by a strong plastic material like epoxy or aramid plastic material, and are hardened by means of heat and pressure.

6. Chair seat according to claim 1, characterized in that each of the flat portions (2a, 2b) of the spring (2) are supported by a U-shaped metal profile, in which the spring can be secured in an optional position in the longitudinal direction for adjusting the spring action, viz. adjacent the curved spring part (8) for a stiff spring action and a further distance from the curved part (8) for a softer spring action.

7. Method for the manufacture of a chair seat according to claim 1, in which a model is formed based on the back, the backside and the thighs corresponding to the person for which the chair is intended to be used,
the model is used for providing a mould of the seat and the backrest in the manufacture of a framework for the seat (4) and the backrest (5) of the chair seat (2) adapted to the said person as concerns shape and size,
a framework (1) is made, corresponding to the shape and size of said model, for forming a thin and flat springs means, for instance a carbon spring,
a spring means material, for instance a carbon fiber material is built up, or is formed on said spring framework (1) and is trussed by means of an epoxy plastic material or an aramid plastic material, or another suitable material,
the spring material complex (2), for instance the composite carbon fiber-spring material is hardened using heat and pressure, one or more springs, for instance composite carbon fiber springs (2) are screwed, riveted or secured in another way to the exterior side or the interior side of the seat (4) part and the backrest part (5), respectively, whereby the springs interconnect the seat (4) and the backrest (5) of the chair seat framework,—cushions are applied and secured to the frameworks for the seat (4) and the backrest (5), and
the integral unit comprising seat and backrest including the composite spring(s) is mounted, as known in the art, on a frame thereby providing a chair, a wheel chair or a similar object.

8. Spring means suited for forming a spring action system between a seat part (4) and a backrest part (5) of a chair seat, characterized in that the spring means comprises one or more thin spring webs formed by a carbon fiber material which is trussed and hardened by heat and pressure together with a strong plastic material, for instance an epoxy or aramid plastic material.

9. Spring means according to claim 8, characterized in that the spring has a coefficient of elasticity of 265-330 Gpa, a tensile strength of 2700-6400 Mpa, a yield point of 0.7-2.7% and a density of 1.77-1.9 kg/dm³.
